(19) United States
(12) Patent Application Publication
(10) Pub. No.: US 2004/0250934 A1
(43) Pub. Date: Dec. 16, 2004

(54) Tires with magnetic strips

(76) Inventor: Randy Hamdan, Dearborn, MI (US)

Correspondence Address: Richard C. Litman, LITMAN LAW OFFICES, LTD., P.O. Box 15035, Arlington, VA, 22215, US

(21) Appl. No.: 10/458,721

(22) Filed: Jun. 11, 2003

(51) Int. Cl. B60C 11/00; B60C 19/00

(52) U.S. Cl. 152/208; 152/151

(57) ABSTRACT

A tire with magnetic strips integrated into the therein. The magnetic strips allow the tire to better grip the road due to the magnetic attraction of the magnetic poles of the Earth The tires provide better traction, less skidding, and better control of the vehicle on wet, muddy, icy, and snow laden, as well as, dry roads. The magnetic strips are embedded into the tire tread. The strips are formed as circumferential bands around the tire, or as bars perpendicularly disposed around the circumference.

### BACKGROUND OF THE INVENTION

1. Field of the Invention

The present invention relates to vehicle pneumatic tires having magnetic strips integrated into the tire.

2. Description of the Related Art

Most of the conventional rubber pneumatic tires are used with air pumped thereinto with or without an inner air-tube. According to such conventional tires, the stability of the tire to remain in frictional engagement with the road surface being traversed is contingent on the tangential area of contact between the tire and the road surface. During periods of inclement weather, it is difficult and almost impossible to maintain sufficient contact of the tires to the road surface, thus maintaining the frictional contact. For example, on a snow-laden road surface, a muddy road surface, or a sandy road surface, it is well known that the frictional contact of the tires to the road is diminished considerably.

One patent, U.S. Pat. No. 3,768,532, issued Oct. 30, 1973 to Arai, describes a rubber tire with magnetic zones formed on the inside face of the tire near the tread and on the inner surface of the tire near the rim. The magnets are placed so the same polarized charges face each other, in order to utilize the repulsive forces in combination with the compressed internal air to maintain the “inflation” characteristics of the tire. Alternatively, the tread and the rim themselves may be magnetized.

U.S. Published patent application No. 0021729 A1, published Sep. 13, 2001 to Papp et al., describes incorporating magnetic elements into rubber mediums to form rubber objects, in particular, tires.

U.S. Pat. No. 4,570,152, issued Feb. 11, 1986 to Melton et al., describes a plurality of magnetic studs embedded in pneumatic tires for monitoring the condition of the tire while rotating on the vehicle.

U.S. Pat. No. 5,520,231, issued May 28, 1996to Myatt, describes a tire having areas of electrical conductivity, used to transmit signals to an integrated circuit embedded in the tire.

U.S. Pat. No. 5,895,854, issued Apr. 20, 1999 to Becherer et al., describes a pneumatic tire having at least one predetermined location having a rubber mixture permeated with magnetizable particles.

U.S. Pat. No. 6,232,767 B1, issued May 15, 2001 to Kawase et al., U.S. Pat. No. 6,246,226 B1, issued Jun. 12, 2001 to Kawase et al., U.S. Pat. No. 6,404,182 B1, issued Jun.11, 2002 to Kawase et al., and European Patent Document No. EP 0 833 162 A2, published Apr. 1, 1998, describe wheel revolution detection devices using magnetic fields.

U.S. Pat. No. 6,308,758 B1, issued Oct. 30, 2001 to Cetin et al., describes a tire having a sidewall with a magnetized outer layer for measuring the dynamic behavior of the tire.

U.S. Pat. No. 6,339,956 B1, issued Jan. 22, 2002 to Huinink et al., describes a pneumatic tire having a plurality of piezoelectric sensors for measuring frictional characteristics of the tire, and delivering electromagnetic signals indicative thereof.

U.S. Pat. No. 6,357,501 B1, issued Mar. 19, 2002 to Becherer et al., describes a method of incorporating magnetizable particles into a rubber tire. Ferromagnetic particles are added into a rubber mixture that is used to form certain parts of the tire.

U.S. Pat. No. 6,492,756 B1, issued Dec. 10, 2002 to Maslov et al., describes a rotary electric motor in which the rotor and stator members are configured as annular and concentric rings.

U.S. Pat. No. 6,496,003 B1, issued Dec. 17, 2002 to Okumura et al., describes a magnetic displacement detecting device in the steering assembly of an automobile.

Japan Patent Document No. 1-266004, published Oct. 24, 1989, describes a linear magnetic track motor used in an amphibian screw type gliding boat.

German Patent Document No. DE 39 42 573 A1, published Jun. 27, 1991, describes a vehicle tires having magnetic markers for measuring the rotational characteristics of the tires.

None of the above inventions and patents, taken either singly or in combination, is seen to describe the instant invention as claimed. Thus tires with magnetic strips solving the aforementioned problems are desired.

### SUMMARY OF THE INVENTION

The invention relates generally to construction of a vehicle tire. More specifically, the invention is a tire with magnetic strips integrated into the tire. The magnetic strips allow the tire to better grip the road due to the magnetic attraction of the magnetic poles of the Earth. The tires provide better traction, less skidding, and better control of the vehicle on wet, muddy, icy, and snow laden, as well as, dry roads.

An object of the present invention is to overcome the above problems of conventional tire by providing a pneumatic tire having improved traction properties for icy and snowy roads, and in particular, good traction properties when used on icy roads.

Another object of the present invention is to provide a pneumatic tire having a magnetic pattern effect in unitary or multiple directions for improving the traction of the tire.

Still another object of the present invention is to provide a pneumatic tire having a magnetic pattern effect in unitary or multiple directions for providing good tire properties for both braking and traction.

Still another object of the present invention is to provide a pneumatic tire having a magnetic pattern effect in unitary or multiple directions for good controllability.

Still another object of the present invention is to provide a pneumatic tire having a magnetic pattern which provides improved properties when driving on wet, muddy, sandy, icy and snowy roads without adverse effects to properties when driving on dry roads.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental elevation view of vehicle on road, showing the magnetic field lines between tires and road surface according to the present invention.

FIG. 2 is a sectioned perspective view of a tire showing the magnetic strips perpendicular to the circumferential direction according to the present invention.

FIG. 3 is a sectioned perspective view of a tire showing the circumferential magnetic strips according to the present invention.

Similar reference characters denote corresponding features consistently throughout the attached drawings.

### DETAILED DESCRIPTION OF THE PREFERRED EMBODIMENTS

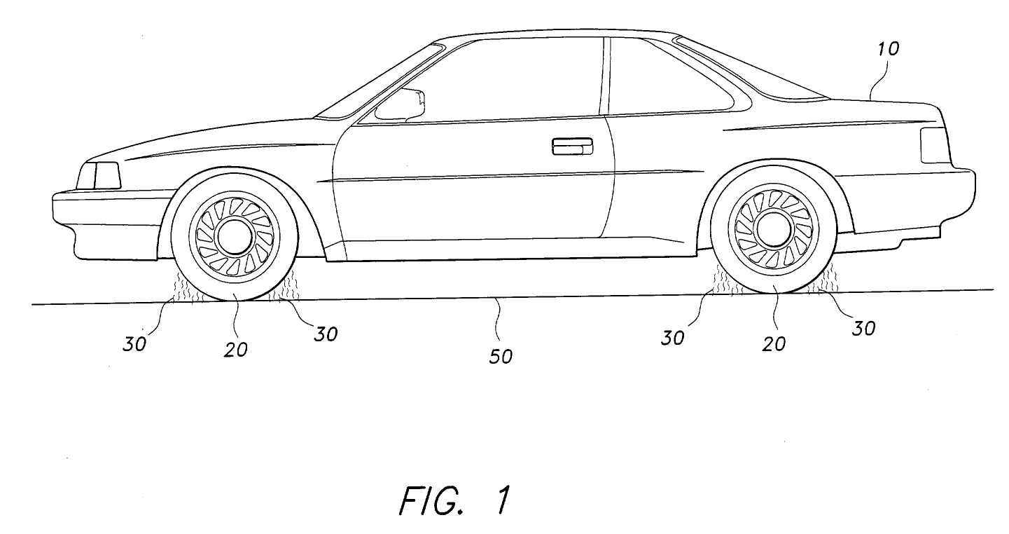

The present invention is described herein in connection with FIGS. 1-3. FIG. 1 illustrates the principles of the invention. A vehicle 10, shown as automobile, having a plurality of tires according to the invention mounted thereon. The vehicle 10 is chosen from any of the myriad of wheeled structures that use pneumatic tires 20 as the rolling medium for traversing any travel surface 50. The vehicle 10 may be a push or pull type device such as a barrow, which includes but not limited to wheelbarrows, handbarrows, dollies, hand trucks, rickshaws, carriages or trailers. The vehicle 10 may be a velocipede, which includes but not limited to unicycles, bicycles, tricycles, scooters, wagons, skates and skateboards. The vehicle 10 may be a motor vehicle 10, which includes but not limited to automobiles, motorcycles, ATV's, RV's, SUV's, trucks, tractors, buses, etc. The peculiarity of the vehicle 10 is that it uses pneumatic tires 20 as the rolling medium between the vehicle 10 and the travel surface 50.

The tire 20, according to the invention, includes a source (not shown FIG. 1) of magnetism that emanates an attractive field of magnetic force, generally shown at 30 of FIG. 1. This attractive force provides an additional component the results in the frictional interaction between the tire 20 and the travel surface 50. The attractive force of the source of magnetism with the travel surface 50, in order to increase the frictional interaction, functions in accordance with fundamental principles of magnetism and the Earth's magnetic field.

First, the Earth's magnetic field interacts with the source of magnetism in the tire 20 so as to create an attraction between the Earth and the source. The resulting attractive force, albeit generally considered to be small with respect to the gravitational force, contributes to the frictional interaction between the tire 20 and the travel surface 50. To increase the usability of this principle, a reliance on specific polar orientation of the source magnetism within the tire 20 would be required.

Also, the orientation would be determined based upon which hemisphere of the Earth the tire 20 is used. A second principle, which has a greater magnitude of attractive force in accordance with the invention, uses the presence of ferromagnetic materials in or near the travel surface 50 upon which the tire 20 will interact. Specifically, the source of magnetism within the tire 20 will emanate the magnetic lines of force toward the travel surface 50, the presence of any ferromagnetic materials in or near the travel surface 50 will allow the attractive forces to increase frictional interaction between the travel surface 50 and the tire 20. In is noted that the greater the presence of ferromagnetic material in or near the travel surface 50, the greater the attractive force component will be present.

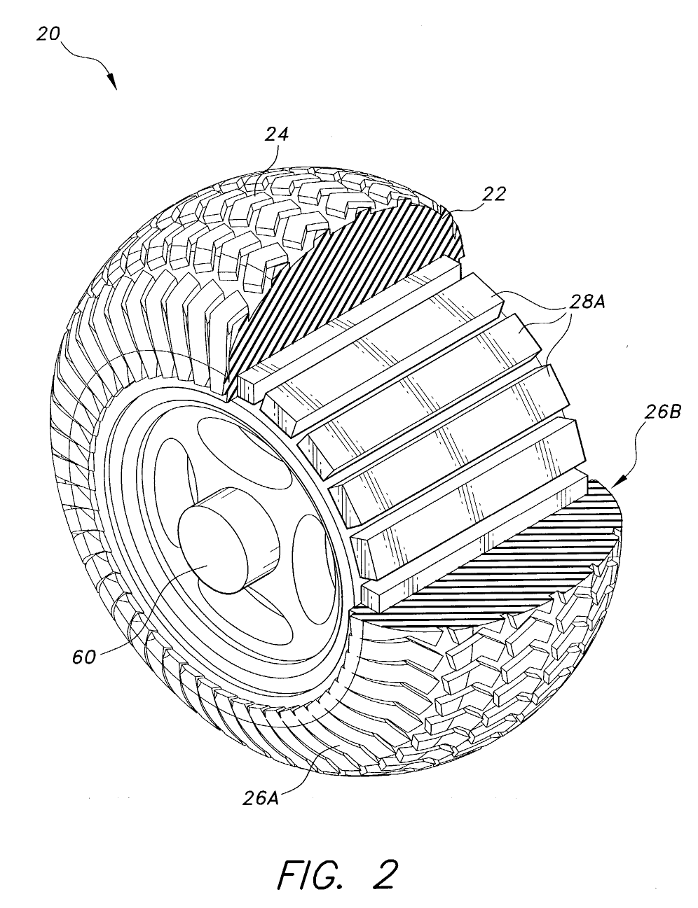

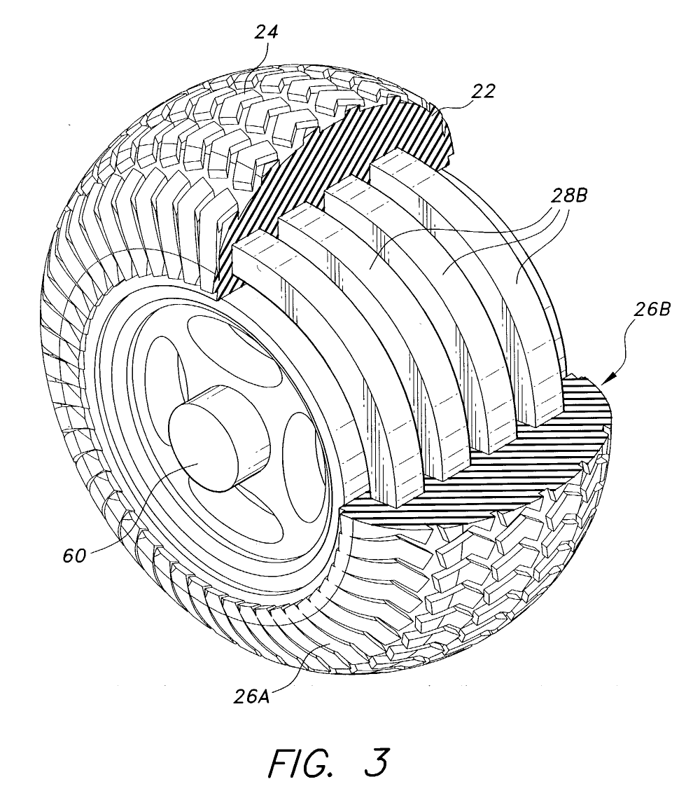

With these principles understood, the structure of the tire 20 will be discussed in accordance with the aspect of the present invention. FIGS. 2 and 3 show two arrangements for the tire 20 according to the invention. It is noted that these two aspects represent a mere fraction of the myriad of structural arrangements for accomplishing the principles according to the invention, and as such are not limited thereto.

In FIGS. 2 and 3, tires 20 of the present invention are shown having a cut away section to illustrate the invention. A rim or wheel 60 is conventional in the art and is attached to the vehicle 10 in a conventional manner. The discussion of such connection will be omitted since it is well established in the art. The pneumatic tire 20 of the invention is mounted on the rim 60 and is inflated to a predetermined air pressure; this is also conventional in the art. The tire 20 includes a carcass formed of a pair of sidewalls 26A, 26B and a tread surface 24 surface 24. The sidewalls 26A, 26B generally have a bead (not shown) around an inner peripheral edge for providing the pneumatic seal between the tire 20 and the rim 60. The tread surface 24 is generally disposed between the sidewalls 26A, 26B, opposite the beaded periphery, so as to form a torroid having a U-shaped cross-section.

The tread surface 24 includes a tread pattern on the surface 24 for increasing traction and frictional interaction between the tire 20 and the travel surface 50. This is a conventional feature because the tread surface 24 allows the displacement of some fluid of near fluid substances from between the circumferential surface of the tread surface 24 and the travel surface 50. For example, fluid substances are commonly referred to as rain, oils, etc., while near fluid substances are on the order of sand, mud, snow, ice, etc.

The carcass 22 is fabricated of rubber (natural, synthetic, or a combination thereof). The carcass 22 may include any chemical additive conventional in the art to maintain the resiliency of the rubber so that the tire 20 maintains its durability and stability.

In addition, the carcass 22 may include steel belts, fiber belts, etc. (also conventional in the art) so as to aid in the stability of the tire 20 as well as preventing punctures due to sharp objects (such as nails, stones, broken glass, etc.) on the travel surface 50. Likewise, the carcass 22 may be fabricated in accordance with any of the standard techniques currently used in the art. These techniques will result in the commonly referred to types of tires 20 such as, but not limited to, ply, biased ply, double ply, and/or radial tires 20.

In accordance with the invention, during the fabrication of the tire 20, a source of magnetism is introduced into the carcass 22. The source of magnetism is at least one magnetic element.

The magnetic element is a bar shaped magnet 28A (FIG. 2), disposed transverse a circumferential directional of the tire 20.

A plurality of bar shaped magnets 28A is shown because in this arrangement an increase of magnetic attractive force would be generated.

Likewise, in accordance with the invention, during the fabrication of the tire 20, a source of magnetism is introduced into the carcass 22. The source of magnetism is at least one magnetic element. The magnetic element is a circumferential band magnet 28B (FIG. 3), disposed circumferentially around the interior of the carcass 22 of the tire 20. A plurality of the circumferential band magnets 28B is shown because in this arrangement an increase of magnetic attractive force would be generated.

In accordance with the second, and more prominent principle, the magnets provide the attractive force to any ferromagnetic material in or near the travel surface 50, in this manner, the vehicle 10 will have increased frictional interaction because of the attractive force added in combination with the gravitational force. With respect to the first principle, the arrangement of the magnets would be predetermined by the Earth's magnetic field. This would require the magnets to be polarized in one direction for the use in the northern hemisphere, and oppositely for use in the southern hemisphere. Although, in accordance with the aspect of the invention, the magnets are shown as bars in FIG. 2 and bands in FIG. 3, it is understood that any arrangement for providing a source of magnetism in the carcass 22 of the tire 20 is well within the scope of the appended claims.

It is to be understood that the present invention is not limited to the embodiments described above, but encompasses any and all embodiments within the scope of the following claims.

I claim:

1. A tire for increased traction comprising:
a carcass including pair of sidewalls, and a ground engaging surface disposed between the pair of sidewalls, such that the carcass has a generally U-shaped cross-section; and
at least one magnetic member embedded in the carcass for emanating magnetic lines of force from the carcass;
wherein the magnetic lines of force emanated from the magnetic member increases the traction of the ground engaging surface by attracting the carcass to a surface of travel.

2. The tire according to claim 1, further comprising:
a tread pattern in the ground engaging surface, the tread pattern forming a friction surface for engaging the surface of travel; whereby the friction surface has an increased coefficient of friction due to the attraction forces from the magnetic member.

3. The tire according to claim 1, wherein the tire is mounted on a tire supporting rim and used on a vehicle.

4. The tire according to claim 3, wherein the tire is mounted on a tire supporting rim and used on a vehicle.

5. The tire according to claim 3, wherein the vehicle is a motor vehicle.

6. The tire according to claim 3, wherein the vehicle is a velocipede.

7. The tire according to claim 3, wherein the vehicle is a barrow.

8. The tire according to claim 3, wherein the vehicle is a trailer.

9. A tire for increased traction comprising:
a pair of sidewalls, each side wall having an inner circular periphery designed and configured as a bead, and an outer circular periphery;
a tread surface disposed between the outer circular periphery of the pair of sidewalls, such that the sidewalls and the tread surface form a torroid having a generally U-shaped cross-section; and
at least one magnetic member embedded in the tread surface for emanating magnetic lines of force from the tread surface;
wherein the magnetic lines of force emanated from the magnetic member increases the traction of the tread surface.

10. The tire according to claim 9, wherein the tread surface further includes a tread pattern, the tread pattern forming a friction surface for engaging a road surface; whereby the friction surface has an increased coefficient of friction due to the attraction forces from the magnetic member.

11. The tire according to claim 9, wherein the tire is mounted on a tire supporting rim and used on a vehicle.

12. The tire according to claim 11, wherein the vehicle is a motor vehicle.

13. The tire according to claim 12, wherein the vehicle is a velocipede.

14. The tire according to claim 12, wherein the vehicle is a barrow.

15. The tire according to claim 12, wherein the vehicle is a trailer.

16. A pneumatic tire comprising:
a pair of sidewalls, each side wall having an inner circular periphery designed and configured as a bead, and an outer circular periphery;
a tread surface disposed between the outer circular periphery of the pair of sidewalls, such that the sidewalls and the tread surface define a carcass in the form of a torroid having a generally U-shaped cross-section; and
magnetic means embedded in the carcass for emanating magnetic lines of force from the carcass;
wherein the magnetic lines of force emanated from the magnetic member increases the traction of the tread surface.

17. The pneumatic tire according to claim 16, further comprising:
at least one reinforcement member embedded in the carcass for maintaining the durability and stability of the carcass.

18. The pneumatic tire according to claim 17, wherein the reinforcement member is chosen from the group consisting of belts, bands, fibers, and chemical compositions for increasing the strength of the carcass.

19. The pneumatic tire according to claim 16, wherein the magnetic means includes a plurality of circumferential bands of magnetic material embedded in the tread surface of the carcass.

20. The pneumatic tire according to claim 16, wherein the magnetic means includes a plurality of bar shaped magnetic members embedded in the carcass, and disposed transverse to the circumferential direction of the carcass.
